(19) United States
(12) Patent Application Publication
(10) Pub. No.: US 2013/0185225 A1
(43) Pub. Date: Jul. 18, 2013

(54) INVESTMENT METHOD OF AUTOMATIC COST ADJUSTMENT

(71) Applicants: Jiunn-Lieh Liu, Taichung City (TW); Ssu-Kai Chien, Taichung City (TW); Wen-Che Mei, Taichung City (TW)

(72) Inventors: Jiunn-Lieh Liu, Taichung City (TW); Ssu-Kai Chien, Taichung City (TW); Wen-Che Mei, Taichung City (TW)

(21) Appl. No.: 13/548,230

(22) Filed: Jul. 13, 2012

(30) Foreign Application Priority Data
Jan. 13, 2012 (TW) 101101424

(51) Int. Cl. G06Q 40/06

(52) U.S. Cl. 705/36 R

(57) ABSTRACT

An investment method of automatic cost adjustment includes an X ratio defined as a total net value of the target fund which the investor paid divided by a total cost of the target fund which the investor paid, a first ratio and a second ratio respectively defined as the standards for the investor to compare with the X ratio and further adjust his or her budget into the investment. Under this arrangement, the investment method keeps monitoring the situation of the X ratio and further requests the investor to buy more amounts of the target fund for investment or to sell out the whole target fund for earning money.

### BACKGROUND OF THE INVENTION

1. Field of the Invention

The present invention relates to an investment strategy and more particularly to an investment method of automatic cost adjustment.

2. Description of Related Art

It is well known that average investors can invest in various target mutual funds around the world through licensed investment agent to deal with the investment. Commonly, the ways investment agent employs to invest in the target fund are Lump-sum method and Dollar-cost averaging method.

The so-called Lump-sum method is that the investor provides a certain amount of budget to the investment agent, and then the investment agent accordingly uses this budget to buy a target fund. The advantage of lump-sum method is that if you invest at the right time at the right price (low price), you have the potential of making big gain. On the other hand, if you invest at the wrong market timing at a wrong price (high price), the chances about losing money is high.

To flatten the losing risk, consequently, the investment agent often adopts the Dollar-cost averaging method instead of the Lump-sum method. In its best known form, an investor is counseled to invest the money over a period of time in equal installments in order to avoid the devastating effect of a market fall immediately after a single, lump-sum investment.

However, current Dollar-Cost Averaging strategy is questionable due to the mechanism of current DCA strategy is not sufficient to help investors to make profit, and it is also not an appropriate investing toll for long-term investment without proper management. When investor decides to utilize Dollar-Costing Averaging to invest in mutual funds, the information he will receive usually is the fund performance in the past. But investors is totally unaware of the fact that before his investing portfolio could make expected profit, to what degree the volatility he needs to tolerate (such as meaning what's the maximum investment loss he might need to put up with and how long will the investment loss last). These are important factors to impact investor's attitude toward his investing plan and also affect investor's faith to stick to the strategy, which happens to be the key to the success of DCA strategy.

The present invention has arisen to mitigate and/or obviate the disadvantages of the conventional. Further benefits and advantages of the present invention will become apparent after a careful reading of the detailed description with appropriate reference to the accompanying drawings.

### SUMMARY OF THE INVENTION

The main objective of the present invention is to provide an improved investment method.

To achieve the objective, a investment method of automatic cost adjustment comprises an X ratio, a first ratio, a second ratio, a first investment cost and a second investment cost, the X ratio defined as a total net value of the target fund possessed by the investor divided by a total cost of the target fund which the investor paid, the first ratio and the second ratio respectively defined as the variables for the investor to compare with the X ratio and subsequently adjust his or her budget into the investment, the first investment cost defined for the investor to buy the certain amounts of the target fund for investment, the second investment cost defined for the investor to buy more amounts of the target fund for investment, a first condition defined as that the X ratio≧1, a second condition defined as that the X ratio≧the first ratio, a third condition defined as that the X ratio≧the second ratio.

Under this arrangement, the first embodiment is shown as following. When an planned investment time approaches, the investment method determines whether the X ratio satisfied with the first condition or not; if the X ratio is satisfied with the first condition, the investment method subsequently determines whether the X ratio satisfied with the second condition or not; if the X ratio is satisfied with the second condition, the investment method enters into a selling process which is defined as that the investment method automatically requests the investment agent to sell out the own target fund which the investor paid; else the investment method enters a first buying process defined as that the investment method automatically enforces the investment agent to invest the certain amounts of the target fund based on the first investment cost at that time; thereafter, the investment method continuously determines whether the iterative X ratio satisfied with the first condition and the second condition simultaneously or not; if the iterative X ratio satisfied with the first condition and the second condition simultaneously, the investment method enters into the selling process for earning money; else the investment method is continuous until the iterative X ratio satisfied with the first condition and the second condition simultaneously; and if the X ratio is not satisfied with the first condition, the investment method determines whether the X ratio satisfied with the third condition or not; if the X ratio is satisfied with the third condition, the investment method enters into the first buying process again; else the investment method enters into a second buying process which is defined as that the investment method automatically enforces the investment agent to buy more amounts of the target fund based on the second investment cost at that time; thereafter, the investment method continuously determines whether the iterative X ratio satisfied with the first condition and the second condition simultaneously or not; if the iterative X ratio satisfied with the first condition and the second condition simultaneously, the investment method enters into the selling process for earning money; else the investment method is continuous until the iterative X ratio satisfied with the first condition and the second condition simultaneously.

The second embodiment is shown as following. The investment method of automatic cost adjustment comprising an X ratio, a first ratio, a second ratio, a first investment cost and a third investment cost, the X ratio defined as a total net value of the target fund which the investor paid divided by a total cost of the target fund which the investor paid, the first ratio and the second ratio respectively defined as the standards for the investor to compare with the X ratio and further adjust his or her budget into the investment, the first investment cost defined for the investor to buy the certain amounts of the target fund for investment, the third investment cost defined for the investor to buy more amounts of the target fund for investment, the fourth investment cost defined for the investor to buy much more amounts of the target fund for investment, a first condition defined as that the X ratio≧1, a second condition defined as that the X ratio≧the first ratio, a third condition defined as that the X ratio≧the second ratio. When the investment time approaches, the investment method determines whether the X ratio satisfied with the first condition or not; if the X ratio is satisfied with the first condition, the investment method determines whether the X ratio satisfied with the second condition or not; if the X ratio is satisfied with the second condition, the investment method enters into a selling process which is defined as that the investment method automatically requests the investment agent to sell out the own target fund which the investor paid; else the investment method enters the first buying process which is defined as that the investment method automatically requests the investment agent to invest the certain amounts of the target fund at that time by using the first investment cost; thereafter, the investment method continuously determines whether the iterative X ratio satisfied with the first condition and the second condition simultaneously or not; if the iterative X ratio satisfied with the first condition and the second condition simultaneously, the investment method enters into the selling process for earning money; else the investment method is continuous until the iterative X ratio satisfied with the first condition and the second condition simultaneously; and if the X ratio is not satisfied with the first condition, the investment method determines whether the X ratio satisfied with the third condition or not; if the X ratio is satisfied with the third condition, the investment method enters into a third buying process which is defined as that the investment method automatically requests the investment agent to invest more amounts of the target fund at that time by using the third investment cost; thereafter, the investment method continuously determines whether the iterative X ratio satisfied with the first condition and the second condition simultaneously or not; if the iterative X ratio satisfied with the first condition and the second condition simultaneously, the investment method enters into the selling process for earning money; else the investment method is continuous until the iterative X ratio satisfied with the first condition and the second condition simultaneously. The investment method of automatic cost adjustment further comprises a fourth investment cost; wherein, if the X ratio is not satisfied with the third condition, else the investment method enters into a fourth buying process which is defined as that the investment method automatically requests the investment agent to buy much more amounts of the target fund at that time by using the fourth investment cost; thereafter, the investment method continuously determines whether the iterative X ratio satisfied with the first condition and the second condition simultaneously or not; if the iterative X ratio satisfied with the first condition and the second condition simultaneously, the investment method enters into the selling process for earning money; else the investment method is continuous until the iterative X ratio satisfied with the first condition and the second condition simultaneously.

The third embodiment is shown as following. The investment method of automatic cost adjustment comprising an X ratio, a first ratio, a second ratio, a third ratio, a first investment cost, a second investment cost and a fifth investment cost, the X ratio defined as a total net value of the target fund which the investor paid divided by a total cost of the target fund which the investor paid, the first ratio, the second ratio and the third ratio respectively defined as the standards for the investor to compare with the X ratio and further adjust his or her budget into the investment, the first investment cost defined for the investor to buy the certain amounts of the target fund for investment, the second investment cost defined for the investor to buy more amounts of the target fund for investment, the fifth investment cost defined for the investor to buy less amounts of the target fund for investment. a first condition defined as that the X ratio≧1, a second condition defined as that the X ratio≧the first ratio, a third condition defined as that the X ratio≧the second ratio, a further condition defined as that the X ratio≧the third ratio; wherein, when the investment time approaches, the investment method determines whether the X ratio satisfied with the first condition or not; if the X ratio is satisfied with the first condition, the investment method determines whether the X ratio satisfied with the further condition or not; if the X ratio is satisfied with the further condition, the investment method determines whether the X ratio satisfied with the second condition or not; if the X ratio is satisfied with the second condition, the investment method enters into the selling process which is defined as that the investment method automatically requests the investment agent to sell out the own target fund which the investor paid; else the investment method enters into a fifth buying process which is defined as that the investment method automatically requests the investment agent to invest less amounts of the target fund at that time by using the fifth investment cost; thereafter, the investment method continuously determines whether the iterative X ratio satisfied with the first condition and the second condition simultaneously or not; if the iterative X ratio satisfied with the first condition and the second condition simultaneously, the investment method enters into the selling process for earning money; else the investment method is continuous until the iterative X ratio satisfied with the first condition and the second condition simultaneously; and if the X ratio is not satisfied with the first condition, the investment method determines whether the X ratio satisfied with the third condition or not; if the X ratio is satisfied with the third condition, the investment method enters into the first buying process again; else the investment method enters into a second buying process which is defined as that the investment method automatically requests the investment agent to buy more amounts of the target fund at that time by using the second investment cost; thereafter, the investment method continuously determines whether the iterative X ratio satisfied with the first condition and the second condition simultaneously or not; if the iterative X ratio satisfied with the first condition and the second condition simultaneously, the investment method enters into the selling process for earning money; else the investment method is continuous until the iterative X ratio satisfied with the first condition and the second condition simultaneously; if the X ratio is not satisfied with the further condition, the investment method enters into the first buying process which is defined as that the investment method automatically requests the investment agent to invest the certain amounts of the target fund at that time by using the first investment cost.

Wherein, the value of the first ratio is more than one; the value of the first ratio is 1.25; the value of the second ratio is less than one; the value of the second ratio is 0.8; the second investment cost is more than the first investment cost; the second investment cost is the double of the first investment cost; the third investment cost is more than the first investment cost; the third investment cost is the double of the first investment cost; the fourth investment cost is more than the third investment cost; the fourth investment cost is the triple of the first investment cost; the value of third ratio is less than the value of the first ratio and the value of the third ratio is more than one; the fifth investment cost is less than the first investment cost.

Further benefits and advantages of the present invention will become apparent after a careful reading of the detailed description with appropriate reference to the accompanying drawings.

### BRIEF DESCRIPTION OF THE DRAWINGS

FIG. 1 is a flow chart for showing an investment method of automatic cost adjustment of the present invention;

FIG. 2 is the flow chart for showing the second embodiment of the present invention; and

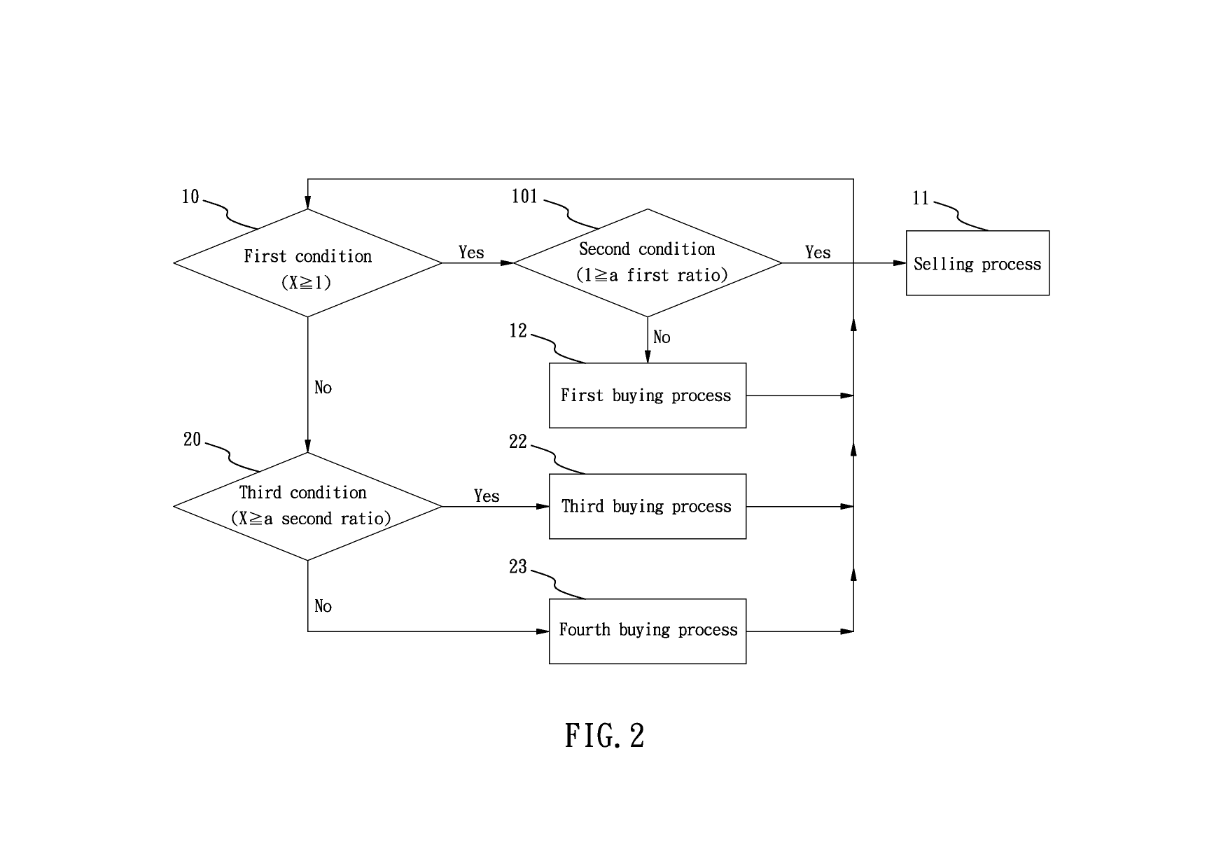

FIG. 3 is the flow chart for showing the third embodiment of the present invention.

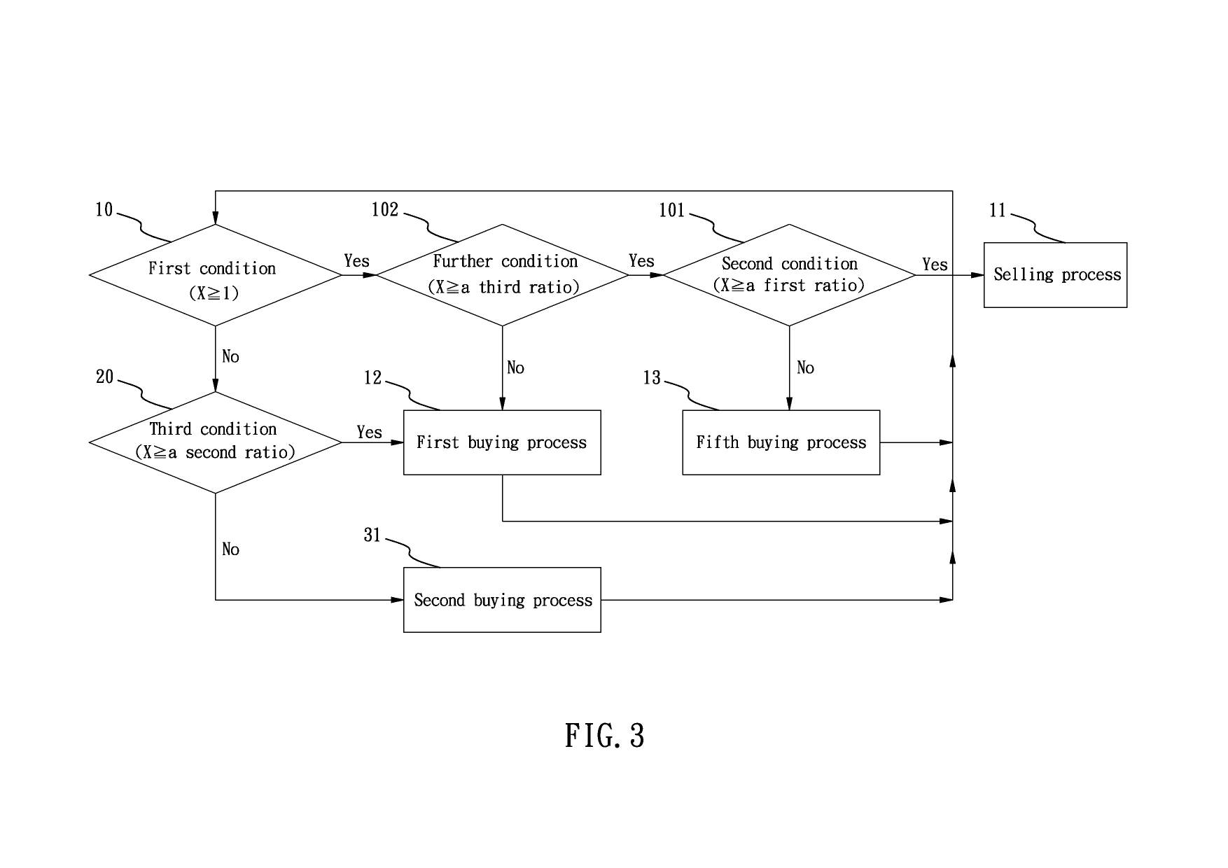

### DETAILED DESCRIPTION OF THE INVENTION

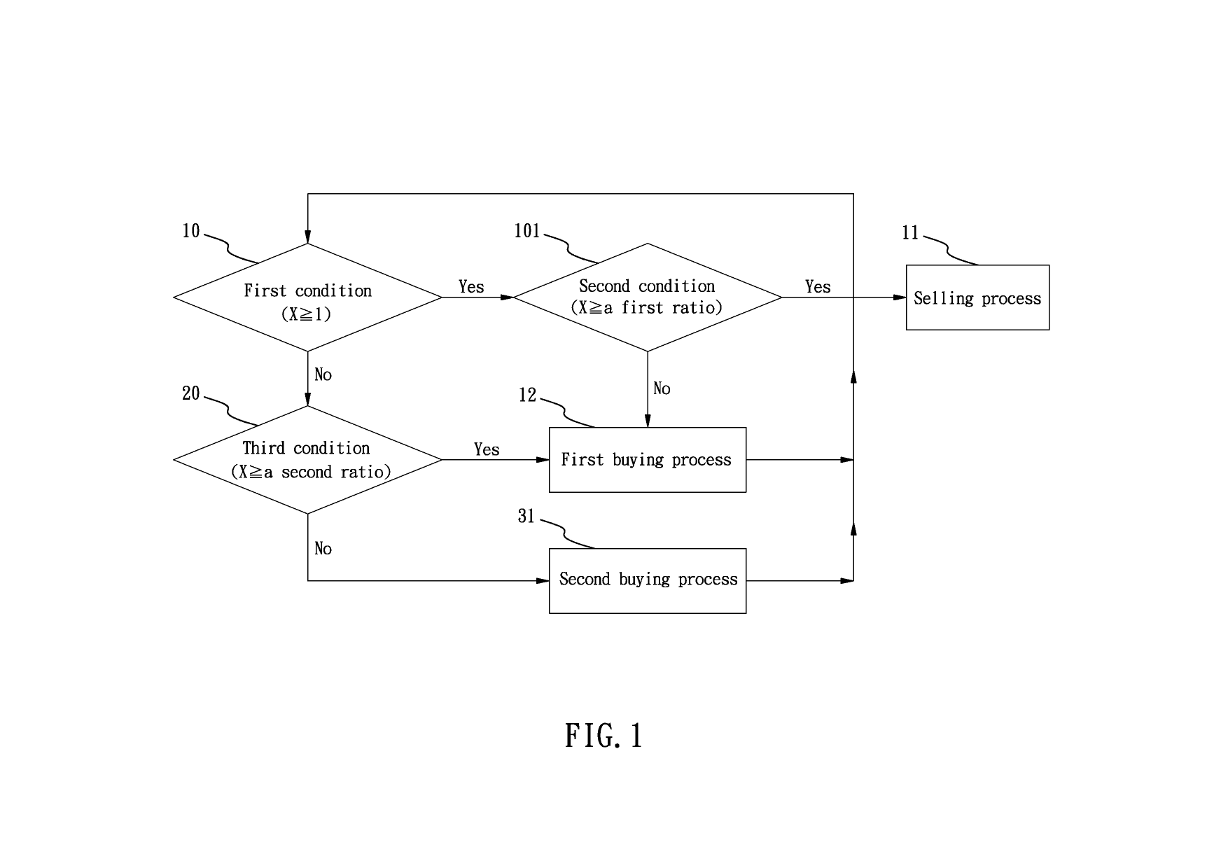

Referring to FIG. 1, an investment method of automatic cost adjustment in accordance with the present invention improves the Dollar-cost averaging method, such that the investors can reduce risk in their investment. The investment method of automatic cost adjustment comprises an X ratio, a first ratio, a second ratio, a first investment cost and a second investment cost. The X ratio is defined as a total net value of the target fund which the investor paid divided by a total cost of the target fund which the investor paid. The first ratio and the second ratio are respectively defined as the standards for the investor to compare with the X ratio and further adjust his or her budget into the investment. The first investment cost is defined for the investor to buy the certain amounts of the target fund for investment. The second investment cost is defined for the investor to buy more amounts of the target fund for investment. A first condition 10 is defined as that the X ratio≧1. A second condition 101 is defined as that the X ratio≧the first ratio. A third condition 20 is defined as that the X ratio≧the second ratio.

Under this arrangement, when an investment time approaches, the investment method determines whether the X ratio satisfied with the first condition 10 or not. If the X ratio is satisfied with the first condition 10, the investment method determines whether the X ratio satisfied with the second condition 101 or not. If the X ratio is satisfied with the second condition 101, the investment method enters into a selling process 11 which is defined as that the investment method automatically requests the investment agent to sell out the whole target fund which the investor paid; else the investment method enters a first buying process 12 which is defined as that the investment method automatically requests the investment agent to invest the certain amounts of the target fund at that time by using the first investment cost. Thereafter, the investment method continuously determines whether the iterative X ratio satisfied with the first condition 10 and the second condition 101 simultaneously or not. If the iterative X ratio satisfied with the first condition 10 and the second condition 101 simultaneously, the investment method enters into the selling process 11 for earning money; else the investment method is continuous until the iterative X ratio satisfied with the first condition 10 and the second condition 101 simultaneously.

If the X ratio is not satisfied with the first condition 10, the investment method determines whether the X ratio satisfied with the third condition 20 or not. If the X ratio is satisfied with the third condition 20, the investment method enters into the first buying process 12 again; else the investment method enters into a second buying process 31 which is defined as that the investment method automatically requests the investment agent to buy more amounts of the target fund at that time by using the second investment cost. Thereafter, the investment method continuously determines whether the iterative X ratio satisfied with the first condition 10 and the second condition 101 simultaneously or not. If the iterative X ratio satisfied with the first condition 10 and the second condition 101 simultaneously, the investment method enters into the selling process 11 for earning money; else the investment method is continuous until the iterative X ratio satisfied with the first condition 10 and the second condition 101 simultaneously.

Furthermore, the value of the first ratio is more than one such as 1.25. The value of the second ratio is less than one such as 0.8. The second investment cost is more than the first investment cost. The second investment cost is the double of the first investment. The period of time for the investor to regularly provide a piece of budget might be one week, one month, two months, three months or six months.

The second embodiment of the present invention is further described as following. The investment method of automatic cost adjustment further comprises a third investment cost and a fourth investment cost. The third investment cost is defined for the investor to buy more amounts of the target fund for investment. The fourth investment cost is defined for the investor to buy much more amounts of the target fund for investment.

Under this arrangement, when the investment time approaches, the investment method determines whether the X ratio satisfied with the first condition 10 or not. If the X ratio is satisfied with the first condition 10, the investment method determines whether the X ratio satisfied with the second condition 101 or not. If the X ratio is satisfied with the second condition 101, the investment method enters into a selling process 11 which is defined as that the investment method automatically requests the investment agent to sell out the whole target fund which the investor paid; else the investment method enters the first buying process 12 which is defined as that the investment method automatically requests the investment agent to invest the certain amounts of the target fund at that time by using the first investment cost. Thereafter, the investment method continuously determines whether the iterative X ratio satisfied with the first condition 10 and the second condition 101 simultaneously or not. If the iterative X ratio satisfied with the first condition 10 and the second condition 101 simultaneously, the investment method enters into the selling process 11 for earning money; else the investment method is continuous until the iterative X ratio satisfied with the first condition 10 and the second condition 101 simultaneously.

If the X ratio is not satisfied with the first condition 10, the investment method determines whether the X ratio satisfied with the third condition 20 or not. If the X ratio is satisfied with the third condition 20, the investment method enters into a third buying process 22 which is defined as that the investment method automatically requests the investment agent to invest more amounts of the target fund at that time by using the third investment cost; else the investment method enters into a fourth buying process 23 which is defined as that the investment method automatically requests the investment agent to buy much more amounts of the target fund at that time by using the fourth investment cost. Thereafter, the investment method continuously determines whether the iterative X ratio satisfied with the first condition 10 and the second condition 101 simultaneously or not. If the iterative X ratio satisfied with the first condition 10 and the second condition 101 simultaneously, the investment method enters into the selling process 11 for earning money; else the investment method is continuous until the iterative X ratio satisfied with the first condition 10 and the second condition 101 simultaneously.

Furthermore, the third investment cost is more than the first investment cost. The third investment cost is the double of the first investment cost. The fourth investment cost is more than the third investment cost. The fourth investment cost is the triple of the first investment cost. The period of time for the investor to regularly provide a piece of budget might be one week, one month, two months, three months or six months. Therefore, when the total net value of the target fund which the investor paid is lower than the total cost of the target fund which the investor paid, the investor invests more amounts of the target fund at that time by using the third investment cost or the fourth investment cost which are respectively more than the first investment cost or the second investment cost of the first embodiment.

The third embodiment of the present invention is further described as following. The investment method of automatic cost adjustment further comprises a third ratio and a fifth investment cost. The third ratio is defined as the standards for the investor to compare with the X ratio and further adjust his or her budget into the investment. The fifth investment cost is defined for the investor to buy less amounts of the target fund for investment. A further condition 102 is defined as that the X ratio≧the third ratio.

Under this arrangement, when the investment time approaches, the investment method determines whether the X ratio satisfied with the first condition 10 or not. If the X ratio is satisfied with the first condition 10, the investment method determines whether the X ratio satisfied with the further condition 102 or not. If the X ratio is satisfied with the further condition 102, the investment method determines whether the X ratio satisfied with the second condition 101 or not; else the investment method enters into the first buying process 12 which is defined as that the investment method automatically requests the investment agent to invest the certain amounts of the target fund at that time by using the first investment cost. If the X ratio is satisfied with the second condition 101, the investment method enters into the selling process 11 which is defined as that the investment method automatically requests the investment agent to sell out the own target fund which the investor paid; else the investment method enters into a fifth buying process 13 which is defined as that the investment method automatically requests the investment agent to invest less amounts of the target fund at that time by using the fifth investment cost. Thereafter, the investment method continuously determines whether the iterative X ratio satisfied with the first condition 10 and the second condition 101 simultaneously or not. If the iterative X ratio satisfied with the first condition 10 and the second condition 101 simultaneously, the investment method enters into the selling process 11 for earning money; else the investment method is continuous until the iterative X ratio satisfied with the first condition 10 and the second condition 101 simultaneously.

If the X ratio is not satisfied with the first condition 10, the investment method determines whether the X ratio satisfied with the third condition 20 or not. If the X ratio is satisfied with the third condition 20, the investment method enters into the first buying process 12 again; else the investment method enters into a second buying process 31 which is defined as that the investment method automatically requests the investment agent to buy more amounts of the target fund at that time by using the second investment cost. Thereafter, the investment method continuously determines whether the iterative X ratio satisfied with the first condition 10 and the second condition 101 simultaneously or not. If the iterative X ratio satisfied with the first condition 10 and the second condition 101 simultaneously, the investment method enters into the selling process 11 for earning money; else the investment method is continuous until the iterative X ratio satisfied with the first condition 10 and the second condition 101 simultaneously.

Furthermore, the value of third ratio is less than the value of the first ratio and the value of the third ratio is more than one such as 1.2. The fifth investment cost is less than the first investment cost. The period of time for the investor to regularly provide a piece of budget might be one week, one month, two months, three months or six months. Therefore, when the total net value of the target fund which the investor paid is higher than the total cost of the target fund which the investor paid, the investor invests less amounts of the target fund at that time by using the fifth investment cost which is less than the first investment cost of the first embodiment.

All in all, the investment method of automatic cost adjustment of the present invention not only help the both investor and the investment agent to monitor the situation of the total net value of the target fund owned by the investor and the situation of the total cost of the target fund which the investor paid, but also automatically requests the investor or the investment agent to make a suitable decision. The investment method of automatic cost adjustment might be performed by software (such as a program) which is written into hardware (such as a computer) rather than hands-on operation.

Although the invention has been explained in relation to its preferred embodiment, it is to be understood that many other possible modifications and variations can be made without departing from the spirit and scope of the invention as hereinafter claimed.

What is claimed is:

1. An investment method of automatic cost adjustment for improving the Dollar-cost averaging method comprising an X ratio, a first ratio, a second ratio, a first investment cost and a second investment cost, the X ratio defined as a total net value of the target fund which the investor paid divided by a total cost of the target fund which the investor paid, the first ratio and the second ratio respectively defined as the standards for the investor to compare with the X ratio and further adjust his or her budget into the investment, the first investment cost defined for the investor to buy the certain amounts of the target fund for investment, the second investment cost defined for the investor to buy more amounts of the target fund for investment, a first condition defined as that the X ratio≧1, a second condition defined as that the X ratio≧the first ratio, a third condition defined as that the X ratio≧the second ratio;
wherein, when an planned investment time approaches, the investment method determines whether the X ratio satisfied with the first condition or not; if the X ratio is satisfied with the first condition, the investment method determines whether the X ratio satisfied with the second condition or not; if the X ratio is satisfied with the second condition, the investment method enters into a selling process which is defined as that the investment method automatically requests the investment agent to sell out the own target fund which the investor paid; else the investment method enters a first buying process which is defined as that the investment method automatically requests the investment agent to invest the certain amounts of the target fund at that time by using the first investment cost; thereafter, the investment method continuously determines whether the iterative X ratio satisfied with the first condition and the second condition simultaneously or not; if the iterative X ratio satisfied with the first condition and the second condition simultaneously, the investment method enters into the selling process for earning money; else the investment method is continuous until the iterative X ratio satisfied with the first condition and the second condition simultaneously; and
if the X ratio is not satisfied with the first condition, the investment method determines whether the X ratio satisfied with the third condition or not; if the X ratio is satisfied with the third condition, the investment method enters into the first buying process again; else the investment method enters into a second buying process which is defined as that the investment method automatically requests the investment agent to buy more amounts of the target fund at that time by using the second investment cost; thereafter, the investment method continuously determines whether the iterative X ratio satisfied with the first condition and the second condition simultaneously or not; if the iterative X ratio satisfied with the first condition and the second condition simultaneously, the investment method enters into the selling process for earning money; else the investment method is continuous until the iterative X ratio satisfied with the first condition and the second condition simultaneously.

2. The investment method of automatic cost adjustment as claimed in claim 1, wherein the value of the first ratio is more than one.

3. The investment method of automatic cost adjustment as claimed in claim 2, wherein the value of the first ratio is 1.25.

4. The investment method of automatic cost adjustment as claimed in claim 1, wherein the value of the second ratio is less than one.

5. The investment method of automatic cost adjustment as claimed in claim 4, wherein the value of the second ratio is 0.8.

6. The investment method of automatic cost adjustment as claimed in claim 1, wherein the second investment cost is more than the first investment cost.

7. The investment method of automatic cost adjustment as claimed in claim 1, wherein the second investment cost is the double of the first investment.

8. The investment method of automatic cost adjustment comprising an X ratio, a first ratio, a second ratio, a first investment cost and a third investment cost, the X ratio defined as a total net value of the target fund which the investor paid divided by a total cost of the target fund which the investor paid, the first ratio and the second ratio respectively defined as the standards for the investor to compare with the X ratio and further adjust his or her budget into the investment, the first investment cost defined for the investor to buy the certain amounts of the target fund for investment, the third investment cost defined for the investor to buy more amounts of the target fund for investment, the fourth investment cost defined for the investor to buy much more amounts of the target fund for investment, a first condition defined as that the X ratio≧1, a second condition defined as that the X ratio≧the first ratio, a third condition defined as that the X ratio≧the second ratio;
wherein, when the planned investment time approaches, the investment method determines whether the X ratio satisfied with the first condition or not; if the X ratio is satisfied with the first condition, the investment method determines whether the X ratio satisfied with the second condition or not; if the X ratio is satisfied with the second condition, the investment method enters into a selling process which is defined as that the investment method automatically requests the investment agent to sell out the own target fund which the investor paid; else the investment method enters the first buying process which is defined as that the investment method automatically requests the investment agent to invest the certain amounts of the target fund at that time by using the first investment cost; thereafter, the investment method continuously determines whether the iterative X ratio satisfied with the first condition and the second condition simultaneously or not; if the iterative X ratio satisfied with the first condition and the second condition simultaneously, the investment method enters into the selling process for earning money; else the investment method is continuous until the iterative X ratio satisfied with the first condition and the second condition simultaneously; and
if the X ratio is not satisfied with the first condition, the investment method determines whether the X ratio satisfied with the third condition or not; if the X ratio is satisfied with the third condition, the investment method enters into a third buying process which is defined as that the investment method automatically requests the investment agent to invest more amounts of the target fund at that time by using the third investment cost; thereafter, the investment method continuously determines whether the iterative X ratio satisfied with the first condition and the second condition simultaneously or not; if the iterative X ratio satisfied with the first condition and the second condition simultaneously, the investment method enters into the selling process for earning money; else the investment method is continuous until the iterative X ratio satisfied with the first condition and the second condition simultaneously.

9. The investment method of automatic cost adjustment as claimed in claim 8, wherein the investment method of automatic cost adjustment further comprises a fourth investment cost;
wherein, if the X ratio is not satisfied with the third condition, else the investment method enters into a fourth buying process which is defined as that the investment method automatically requests the investment agent to buy much more amounts of the target fund at that time by using the fourth investment cost; thereafter, the investment method continuously determines whether the iterative X ratio satisfied with the first condition and the second condition simultaneously or not;
if the iterative X ratio satisfied with the first condition and the second condition simultaneously, the investment method enters into the selling process for earning money; else the investment method is continuous until the iterative X ratio satisfied with the first condition and the second condition simultaneously.

10. The investment method of automatic cost adjustment as claimed in claim 8, wherein the third investment cost is more than the first investment cost.

11. The investment method of automatic cost adjustment as claimed in claim 10, wherein the third investment cost is the double of the first investment cost.

12. The investment method of automatic cost adjustment as claimed in claim 9, wherein the fourth investment cost is more than the third investment cost.

13. The investment method of automatic cost adjustment as claimed in claim 9, wherein the fourth investment cost is the triple of the first investment cost.

14. The investment method of automatic cost adjustment comprising an X ratio, a first ratio, a second ratio, a third ratio, a first investment cost, a second investment cost and a fifth investment cost, the X ratio defined as a total net value of the target fund which the investor paid divided by a total cost of the target fund which the investor paid, the first ratio, the second ratio and the third ratio respectively defined as the standards for the investor to compare with the X ratio and further adjust his or her budget into the investment, the first investment cost defined for the investor to buy the certain amounts of the target fund for investment, the second investment cost defined for the investor to buy more amounts of the target fund for investment, the fifth investment cost defined for the investor to buy less amounts of the target fund for investment, a first condition defined as that the X ratio≧1, a second condition defined as that the X ratio≧the first ratio, a third condition defined as that the X ratio≧the second ratio, a further condition defined as that the X ratio≧the third ratio;
wherein, when the investment time approaches, the investment method determines whether the X ratio satisfied with the first condition or not; if the X ratio is satisfied with the first condition, the investment method determines whether the X ratio satisfied with the further condition or not; if the X ratio is satisfied with the further condition, the investment method determines whether the X ratio satisfied with the second condition or not; if the X ratio is satisfied with the second condition, the investment method enters into the selling process which is defined as that the investment method automatically requests the investment agent to sell out the own target fund which the investor paid; else the investment method enters into a fifth buying process which is defined as that the investment method automatically requests the investment agent to invest less amounts of the target fund at that time by using the fifth investment cost; thereafter, the investment method continuously determines whether the iterative X ratio satisfied with the first condition and the second condition simultaneously or not; if the iterative X ratio satisfied with the first condition and the second condition simultaneously, the investment method enters into the selling process for earning money; else the investment method is continuous until the iterative X ratio satisfied with the first condition and the second condition simultaneously; and
if the X ratio is not satisfied with the first condition, the investment method determines whether the X ratio satisfied with the third condition or not; if the X ratio is satisfied with the third condition, the investment method enters into the first buying process again; else the investment method enters into a second buying process which is defined as that the investment method automatically requests the investment agent to buy more amounts of the target fund at that time by using the second investment cost; thereafter, the investment method continuously determines whether the iterative X ratio satisfied with the first condition and the second condition simultaneously or not; if the iterative X ratio satisfied with the first condition and the second condition simultaneously, the investment method enters into the selling process for earning money; else the investment method is continuous until the iterative X ratio satisfied with the first condition and the second condition simultaneously.

15. The investment method of automatic cost adjustment as claimed in claim 14, wherein if the X ratio is not satisfied with the further condition, the investment method enters into the first buying process which is defined as that the investment method automatically requests the investment agent to invest the certain amounts of the target fund at that time by using the first investment cost.

16. The investment method of automatic cost adjustment as claimed in claim 14, wherein the value of third ratio is less than the value of the first ratio and the value of the third ratio is more than one.

17. The investment method of automatic cost adjustment as claimed in claim 14, wherein the fifth investment cost is less than the first investment cost.
